(19) United States
(12) Patent Application Publication
(10) Pub. No.: US 2013/0255726 A1
(43) Pub. Date: Oct. 3, 2013

(54) CONDUCTOR CLEANING SYSTEM AND METHOD

(71) Applicants: Andrew J. Phillips, Charlotte, NC (US); Andrew H. Stewart, Fort Collins, CO (US); Shridas Ningileri, Lexington, KY (US); Neil J. Hurst, Fort Collins, CO (US); J. Finley Bush, Leechburg, PA (US); Sike Xia, Pearland, TX (US); Chenghe Xiao, Lexington, KY (US); Yansheng Liu, Lexington, KY (US)

(72) Inventors: Andrew J. Phillips, Charlotte, NC (US); Andrew H. Stewart, Fort Collins, CO (US); Shridas Ningileri, Lexington, KY (US); Neil J. Hurst, Fort Collins, CO (US); J. Finley Bush, Leechburg, PA (US); Sike Xia, Pearland, TX (US); Chenghe Xiao, Lexington, KY (US); Yansheng Liu, Lexington, KY (US)

(73) Assignee: Electric Power Research Institute, Inc., Charlotte, NC (US)

(21) Appl. No.: 13/903,080

(22) Filed: May 28, 2013

Related U.S. Application Data
(62) Division of application No. 12/608,079, filed on Oct. 29, 2009.

(51) Int. Cl. B08B 13/00

(52) U.S. Cl. CPC B08B 13/00
USPC 134/18

(57) ABSTRACT

A conductor cleaning system for cleaning aluminum strands of all aluminum and steel reinforced conductors, such as ACSS, ACSR, ACAR, and AAA. The conductor cleaning system having a container adapted to receive a portion of a conductor to be cleaned, a housing adapted to receive and support the container, and a cleaning solution contained in the container for cleaning the portion of the conductor. The cleaning solution being adapted to clean the conductor without reacting with or damaging the conductor.

This application is a Divisional of U.S. patent application Ser. No. 12/608,079 filed on Oct. 29, 2009, which is a Continuation-In-Part of U.S. patent application Ser. No. 12/357,610 filed on Jan. 22, 2009.

### BACKGROUND OF THE INVENTION

The present invention relates generally to a conductor cleaning system, and more particularly to a system for cleaning aluminum strands of all aluminum and steel reinforced electrical conductors, such as ACSS, ACSR, ACAR, and AAA.

In current power transmission systems, failures can pose a significant risk to the reliability of the system. There are several factors that contribute to these failures—one such factor is the failure of compression connectors.

Current data suggests that a primary root cause for failures in compression connectors is improper installation. Examples of improper installation include lack of compound, alignment, wrong die, and poor cleaning of the aluminum strands of the conductor prior to installation of compression connectors. Research indicates that corrosion products and other contaminants (resulting from years of exposure to the environment) left on the conductors during splice assembly can raise the resistance of the splice-conductor joint (this is also true of new conductors which have oxidation and contaminants thereon). Cyclical variations of load current feeding through the increased resistance of the splice-conductor joint causes thermal expansion/contraction that eventually reduces the grip of the splice to a point where it can no longer hold the conductor.

Currently, compression connector installers clean the aluminum strands with a wire brush, which results in ineffective cleaning of the strands, leaving corrosion products and other contaminants behind. Further, the installer cannot clean internal strands using the wire brush unless the installer takes the time to unstrand the conductor. Unfortunately, unstranding is impractical in most field conditions and can increase the risk of damage to the individual strands.

Accordingly, there is a need for a conductor cleaning system that can effectively clean both outer and inner strands of a conductor without the need to unstrand the conductor.

### BRIEF SUMMARY OF THE INVENTION

These and other shortcomings of the prior art are addressed by the present invention, which provides a conductor cleaning system capable of cleaning external and internal strands of a conductor without unstranding the conductor.

According to one aspect of the present invention, a conductor cleaning system includes a container adapted to receive a portion of a conductor to be cleaned, a housing adapted to receive and support the container, and a cleaning solution contained in the container for cleaning the portion of the conductor. The cleaning solution is adapted to clean the conductor without reacting with or damaging the conductor.

According to another aspect of the present invention, a cleaning solution adapted to clean electrical conductors without damaging galvanization coatings or degrading aluminum contained in the coatings or conductor has a composition, by approximate weight percent, of 0.985 to 8.97 NaOH, 0.49 to 1.45 NaF, and 89.7 to 98.5 H₂O

According to another aspect of the present invention, a method of cleaning an electrical conductor includes providing a conductor cleaning system having a container and an agitator. The method further includes providing a cleaning solution for cleaning of the electrical conductor, introducing the cleaning solution into the container, positioning an electrical conductor in the cleaning solution disposed in the container, and activating the agitator, thereby agitating the cleaning solution and enhancing its ability to clean the electrical conductor.

### BRIEF DESCRIPTION OF THE DRAWINGS

The subject matter that is regarded as the invention may be best understood by reference to the following description taken in conjunction with the accompanying drawing figures in which:

FIG. 1 is a perspective view of a conductor cleaning system according to an embodiment of the invention;

FIG. 2 shows a vibrator housing of the conductor cleaning system of FIG. 1;

FIG. 3 shows an eccentric weight for use in a vibrator of the conductor cleaning system of FIG. 1;

FIG. 4 shows a battery and receptacle for the conductor cleaning system of FIG. 1;

FIG. 5 shows a control panel for the conductor cleaning system of FIG. 1;

FIG. 6 shows the conductor cleaning system of FIG. 1 being carried;

FIG. 7 shows the conductor cleaning system of FIG. 1 in use;

FIGS. 8-10 show the conductor cleaning system of FIG. 1 supported in an upright position by supports;

FIG. 11 shows the conductor cleaning system of FIG. 1 fitted with bi-pods;

FIG. 12 shows a tri-pod for supporting the conductor cleaning system of FIG. 1;

FIG. 13 is a perspective view of a conductor cleaning system according to an embodiment of the invention; and

FIG. 14 is a graph showing pH v. cleaning sequence.

### DETAILED DESCRIPTION OF THE INVENTION

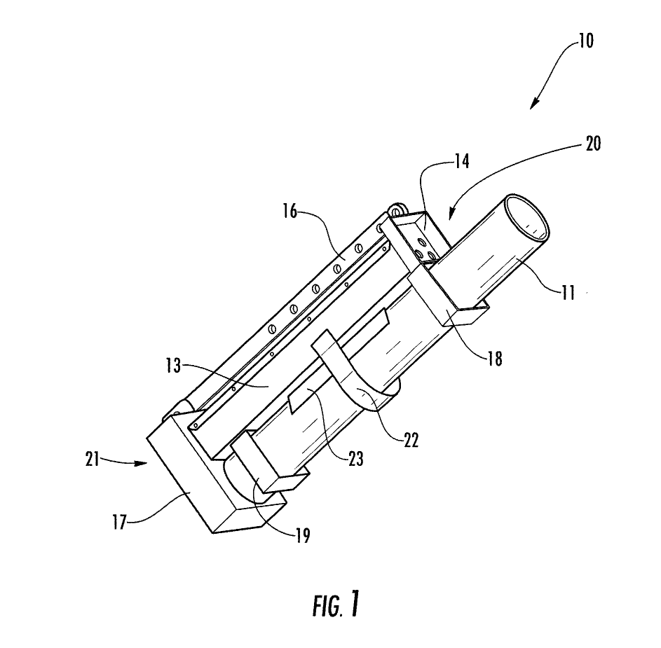

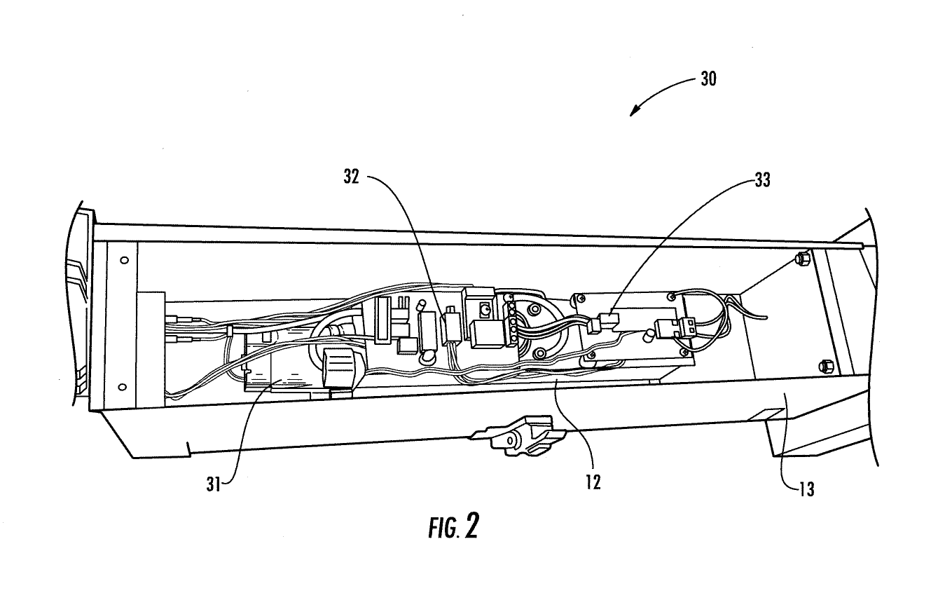

Referring to the drawings, an exemplary conductor cleaning system according to the present invention is illustrated in FIG. 1 and shown generally at reference numeral 10. The system 10 includes a container, such as tube 11 operably connected to an agitator, such as vibrator 12, FIG. 2, contained in a vibrator housing 13, and a control panel 14 for controlling the system 10. The container 11 may be disposable or permanently attached to the system 10.

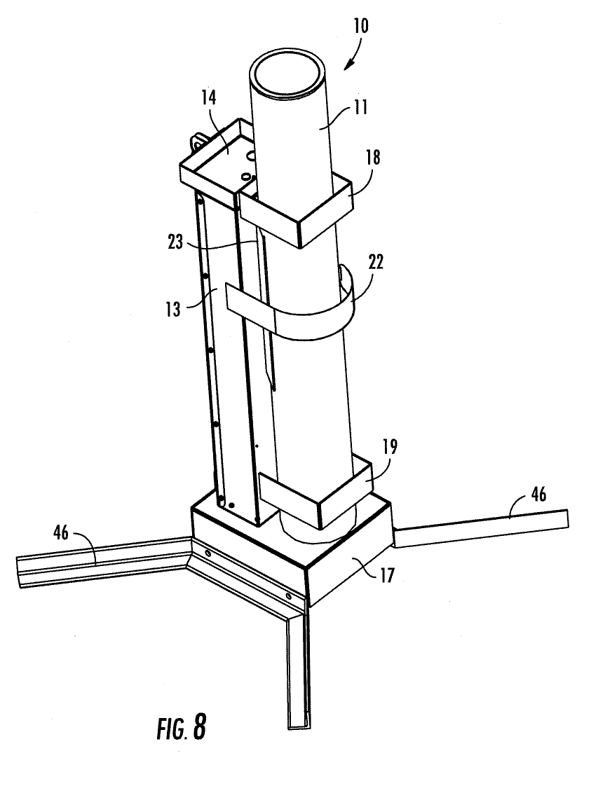

The vibrator housing 13 is adapted to receive and support the container 11, and includes an attachment rail 16 to allow the system 10 to be attached to a support for easy operation or to allow a user to easily carry the system 10. Other attachments such as a hook-type attachment may also be used to attach the system 10 to a bucket of a bucket truck or other suitable support. A standing base 17 is disposed at one end of the housing 13 to allow the system 10 to be positioned in a stand-up position such that the tube 11 is in a vertical position. The base 17 may be adapted to accept supports to further stabilize the system 10 in the vertical position, as shown in FIGS. 8-10. Guide straps 18 and 19 are attached to opposing ends 20 and 21 of the housing 13 to provide guides and supports for the tube 11, and a retaining strap 22 is positioned between the guide straps 18 and 19 to lock the tube 11 into position. A support 23 is also positioned on a bottom of the housing 13 to further position and lock the tube 11 into position. As shown, the support 23 is V-shaped; however, any suitable geometry may be used to position and lock the tube 11 in position.

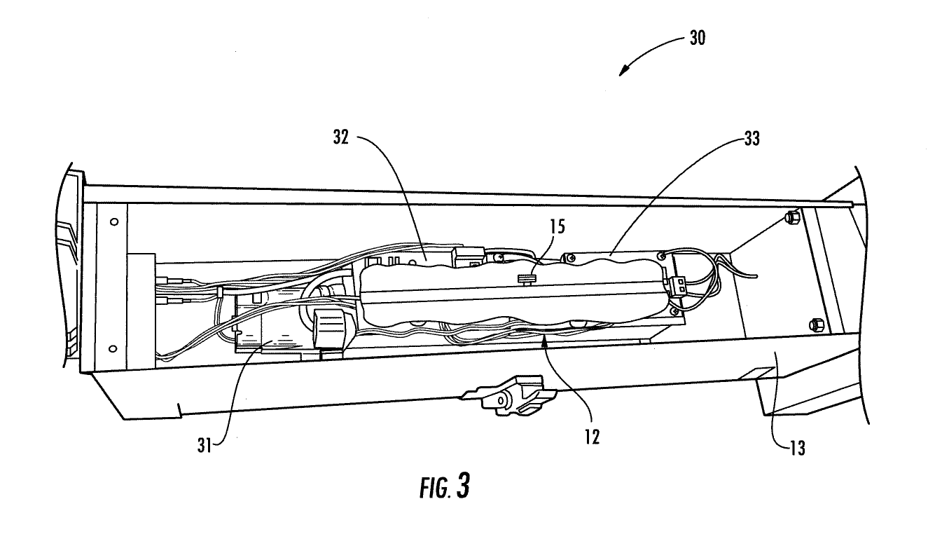

As shown in FIG. 2, the vibrator housing 13 includes a control system 30 having an electric motor 31, a timer circuit 32, a voltage regulator 33, and the vibrator 12. The vibrator 12 includes an eccentric weight 15, like that shown in FIG. 3, to emit vibrations into the tube 11, thereby agitating a cleaning solution contained therein. While a vibrator is being described herein, it should be appreciated that other types of agitators may be used, for example, ultrasonic, bubbling air, and stirring. Together, the motor 31 and vibrator 12 cause the system 10 to vibrate at a specified rate by spinning the eccentric weight 15 at a desired speed. It should be appreciated that the speed of the motor 31 and size of the eccentric weight 15 may be changed to optimize the conductor cleaning efficiency. It should be appreciated that other forms of vibrators/agitators may be used, such as ultrasonic.

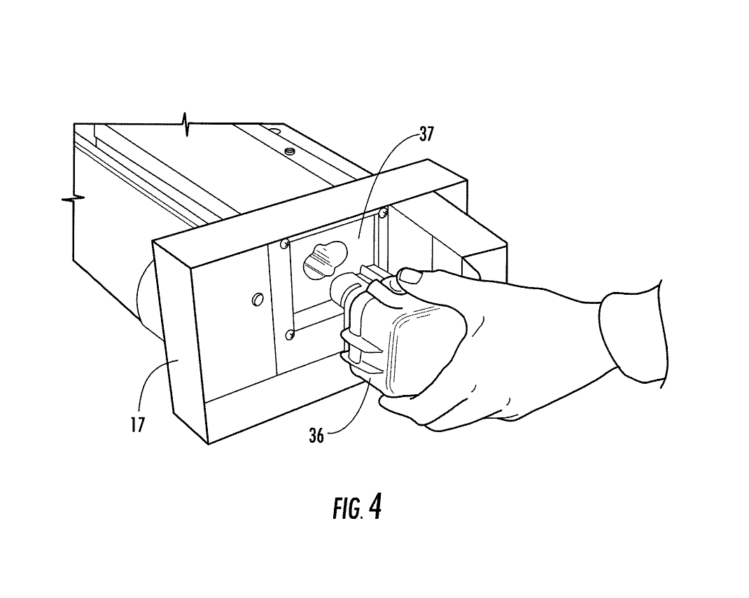

Referring to FIG. 4, the system 10 is powered by a battery 36. The battery 36 is contained in a battery receptacle 37 of the base 17. The battery 36 may be replaceable or rechargeable and allows the system 10 to be portable for conductor cleaning both at ground level and at elevated levels.

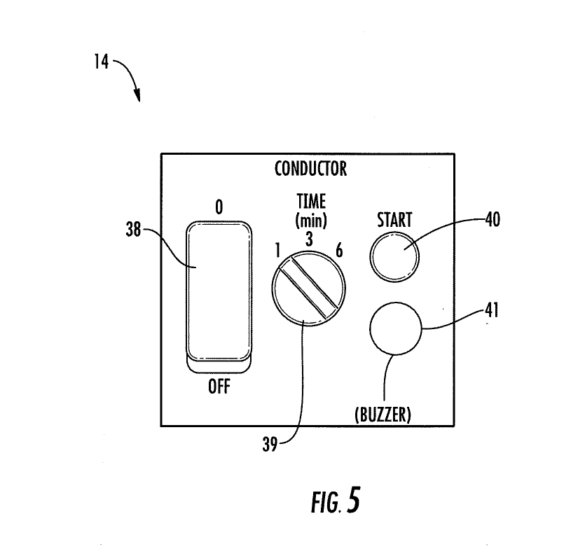

As illustrated in FIG. 5, the control panel 14 is electrically connected to the control system 30 and includes a power switch 38, a timer 39, a start button 40, and a buzzer 41. The power switch 38 turns the system 10 on to a ready state so that the system 10 is ready to clean a conductor. The timer 39 allows a user to choose how long the cleaning process is going to last. The amount of time chosen is dependent on the level of contaminants and corrosion products on the surface of the conductor, temperatures, and other factors. The start button 40 turns the cleaning process on when depressed, and the buzzer 41 lets a user know when the cleaning process has ended.

The cleaning solution is contained in the tube 11 to allow an end of a conductor to be cleaned properly while reducing spills and splashes. The cleaning solution is designed and optimized to permit cleaning of aluminum strands of conductors without unstranding the conductor. Namely, the cleaning solution is designed to permit internal and external cleaning of aluminum strands of the conductor without reacting and damaging the galvanization of galvanized steel strands; to not react with or degrade aluminum strands after the cleaning process is complete; to clean over a wide range of temperatures; to not react with inhibitor compounds used in compression connector installation; and to be environmentally acceptable.

The cleaning solution uses a caustic solution of sodium hydroxide (NaOH) as a cleaning agent due to the tri-hydrated oxide of aluminum found in corrosion products being soluble in this type of solution. It should be appreciated that other suitable caustic hydroxides may be used. The caustic level of the solution is equal to, or less than, that of standard household cleaners. A low concentration of sodium fluoride (NaF) enhances the solubility of the aluminum oxides and reduces the time needed to complete the cleaning. The predominant reactions occurring during cleaning are as follows:

Al₂O₃+2NaOH [symbol] 2NaAlO₂+H₂O

2Al+2NaOH+2H₂O→2NaAlO₃+3H₂.

The reaction products are essentially stable and do not react with Al and the corrosion layer Al₂O₃. Only NaOH chemically attacks both Al and Al₂O₃. Examples of cleaning solutions are shown in the Table below.

Solution

| No. | Composition | Caustic Level |
|---|---|---|
| 1 | NaOH + H₂O | High |
| 2 | NaOH + NaPO₄•12H₂O + NaF + | Medium |
| | H₂O | |
| 3 | NaOH + NaPO₄•12H₂O + NaF + | Medium-Low |
| | H₂O | |
| 4 | NaOH + NaF + H₂O | Low |

In testing, all of the above solutions provided good to excellent cleaning results. For example, in one test, a cleaning solution having a low level of causticity and relatively simple composition was chosen. The cleaning solution had the following concentrations:
Sodium Hydroxide (NaOH)=20 g (approx. weight percent=1.93)
Sodium Fluoride (NaF)=15 g (approx. weight percent=1.45)
Water (H₂O)=1 L. (approx. weight percent=96.62)
   It should be appreciated that other concentrations could be used depending on the application. For example, it was found that solutions having approximate weight percent ranges of 0.985 to 8.97 NaOH, 0.49 to 1.45 NaF, and 89.7 to 98.5 H₂O were acceptable. The chemicals were mixed in the water until completely dissolved. It was determined that the level of cleaning and the time to achieve that level were dependent on the solution temperature and the amount of agitation provided to the solution by the vibrator 12. This can be seen in the table below.

| Temper- | Cleaning Effectiveness Rated 0 to 5 with 5 Being the Best | | | | | |
|---|---|---|---|---|---|---|
| ature | With Agitation | | | Without Agitation | | |
| (C.) | 1 Min | 2.5 Min | 5 Min | 1 Min | 2.5 Min | 5 Min |
| 0 | 3 | 4 | 4 | 1 | 1 | 2 |
| 25 | 4 | 5 | 5 | 2 | 3 | 4 |
| 50 | 5 | 5 | 5 | 5 | 5 | 5 |
| 70 | 5 | 5 | 5 | 5 | 5 | 5 |

It should be appreciated that other forms of agitation may be used, such as ultrasonic, bubbling air, stirring, etc.

When using a cleaning solution with ACSS and other conductors having aluminum incorporated into the steel core's zinc coating, care must be taken to prevent damaging the aluminum in the Al—Zn coating that protects the steel strands of the electrical conductor. The Al—Zn coating protects the steel strands from corrosion and degradation of the coating would be detrimental to the life of the electrical conductor. As a result, it was determined that the use of an inhibitor in the cleaning solution would be beneficial.

It was found that an inhibitor such as sodium silicate (Na₂O(SiO₂₎ₓ(H₂O)ₓ) protected the Al—Zn coating while allowing the cleaning solution to adequately clean the electrical conductor. It was further found that a approximate weight percent range of 0.15 to 1.42 of sodium silicate was acceptable. When mixing the sodium silicate with the cleaning solution it was found that a solution, by approximate weight percent, of (0.15 to 1.42) Na₂O(SiO₂)ₓ(H₂O)ₓ+(1.90 to 1.93) NaOH+(1.43 to 1.45) NaF+(95.24 to 96.47) H₂O adequately cleaned the electrical conductors and protected the Al—Zn coating.

In addition to preventing damage to the Al in the Al—Zn coating, the pH is a concern due to EPA regulations for handling chemical solutions. Thus, it is beneficial to maintain the cleaning solution below a pH of 12.5. It was found, that various chemicals could be used to lower the pH of the solution. For example, it was found that a CaCl₂ solution could lower the pH from 13.0 to 12.4. However, the CaCl₂ solution tends to leave a residue.

It was further found that the use of ascorbic acid provided many benefits that the other chemicals did not. For example, the ascorbic acid was beneficial for both lowering the pH and for protecting the Al—Zn coating. An acceptable range, by approximate weight percent, of ascorbic acid was found to be 0.193 to 3.54. This results in a cleaning solution having a composition, by approximate weight percent, of (0.193 to 3.54) ascorbic acid+(1.87 to 1.93) NaOH+(1.40 to 1.45) NaF+(93.28 to 96.43) H₂O.

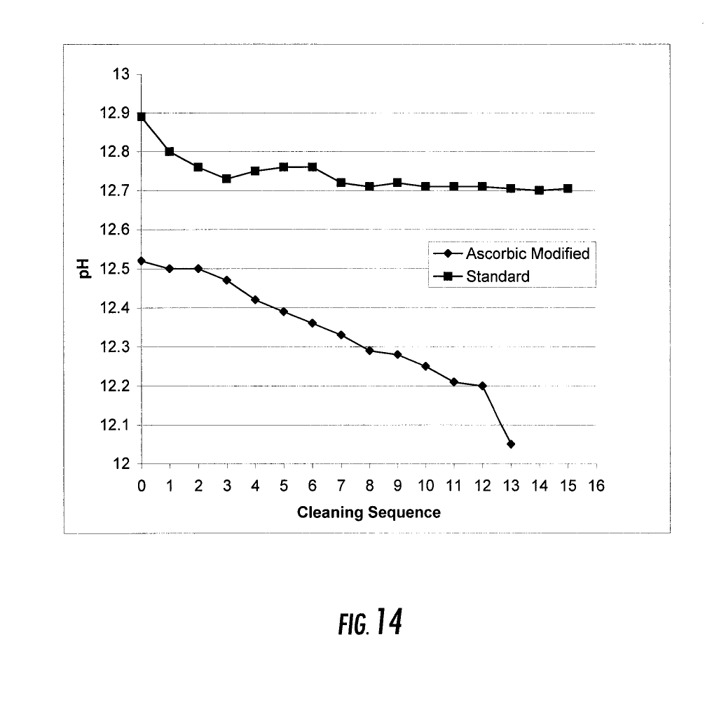

In addition to lowering the pH and protecting the Al—Zn coating, when using the ascorbic acid, it was unexpectedly found that after a certain number of cleanings the pH of the cleaning solution dramatically fell off (See FIG. 14), thereby indicating the need to change the cleaning solution before cleaning any more conductors. This is extremely beneficial because by simply monitoring the pH of the solution, a user knows exactly when to change out the solution for optimum cleaning.

As can be seen from FIG. 14, a cleaning solution without ascorbic acid maintains a fairly constant pH across the cleaning sequences. On the other hand, the ascorbic modified cleaning solution steadily decreases in pH until the cleaning solution becomes ineffective (indicated by the sudden drop off in pH). As such, a user cleaning multiple conductors can monitor the pH of the ascorbic modified solution and easily determine a normal range of drop in pH either visually by graphing pH measurements prior to and after each cleaning, as done in FIG. 14, or by calculating the drop in pH for each cleaning using the pH measurements and then determining a normal range of drop in pH. If during a cleaning, a drop in pH of the cleaning solution exceeds the normal range, then the user knows to dispose of the spent cleaning solution and replace it with new cleaning solution.

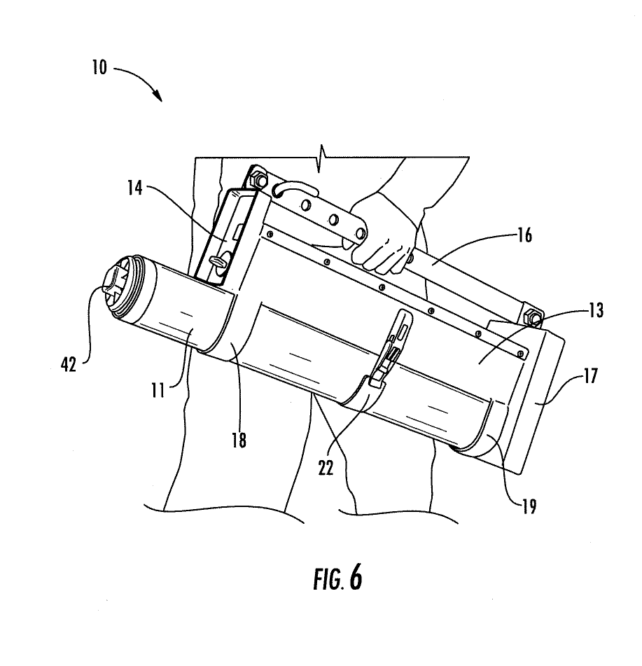

In use, the tube 11 is inserted through the guide straps 18 and 19 of the vibrator housing 13 and secured in position by the retaining strap 22 and support 23. As discussed, the tube 11 may be disposable or permanently attached to the system 10. In the case of a disposable tube, the tube 11 may be pre-filled with the cleaning solution and a plug 42 would be inserted into an end of the tube 11 to prevent spilling of the solution. The tube would then be attached to the system 10 and carried, as shown in FIG. 6, to the conductor cleaning site. After use, the tube 11 would be removed from the system 10 and the tube and cleaning solution would be properly disposed of.

In the case of a permanent tube, the tube 11 would be attached to the system 10 and carried to the conductor cleaning site. The cleaning solution could be poured into the tube 11 and sealed therein by the plug 42 prior to delivery to the cleaning site, could be delivered to the site in another container and then poured into the tube at the site, or could be in powder form which would be mixed with water at the site.

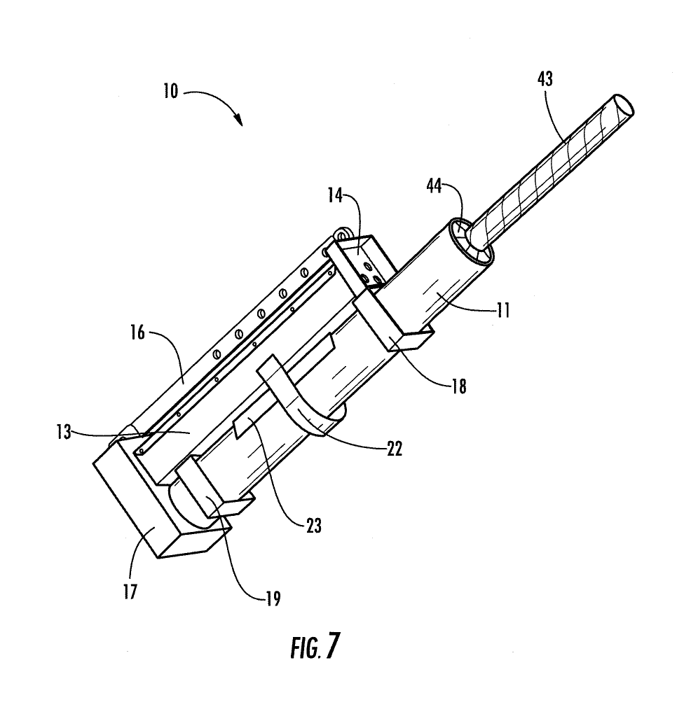

Referring to FIG. 7, once at the conductor cleaning site, a conductor 43 is inserted into the tube 11 so that the cleaning solution contained therein may clean the strands of the conductor 43. A baffle 44 may be inserted into the end of the tube 11 to prevent splashing during the cleaning process. With the conductor 43 positioned in the cleaning solution, the power switch 38 is moved to the on position and the timer 39 is moved to a desired time limit. The duration of vibration is determined by the user depending on the present temperature and the amount of deposits on the conductor surfaces. The start button 40 is then depressed and the motor rotates the eccentric weight 15 of the vibrator 12, thereby causing vibrations to agitate the cleaning solution to ensure that internal and external strands of the conductor are cleaned.

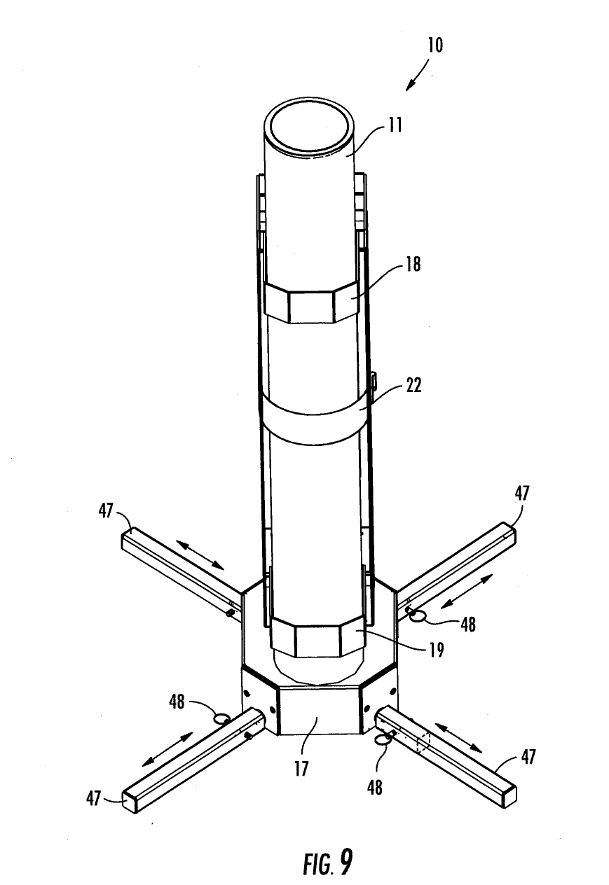

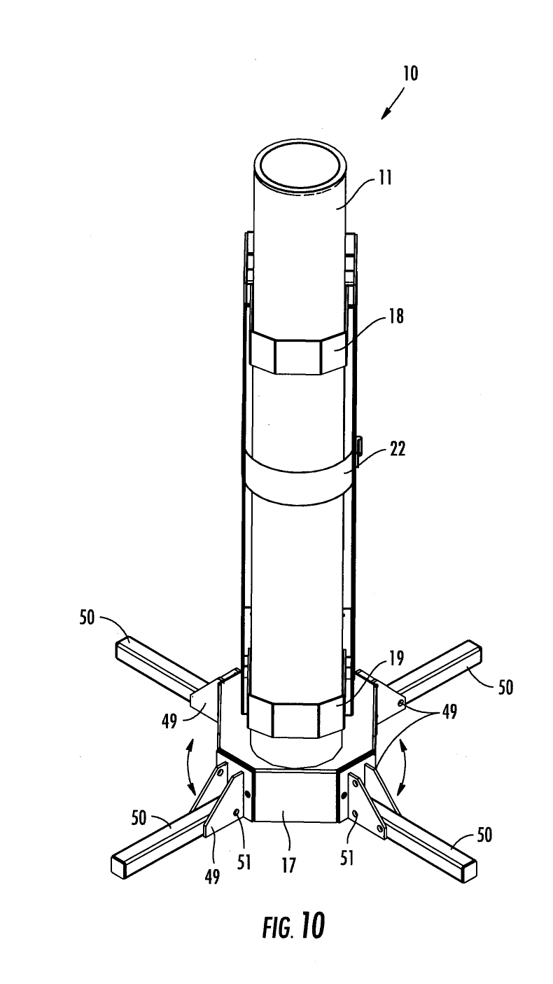

As discussed, during the cleaning cycle of the conductor, the system 10 may be supported in various ways to relieve the burden, on the user, of supporting the system 10. For example, if the system is to be supported in a vertical position, supports may be attached to the base 17, FIGS. 8-10. As shown in FIG. 8, legs 46 are directly attached to the base 17. Legs 46 may be secured to the base 17 using fasteners. As illustrated in FIG. 9, removable legs 47 are secured to the base 17 by pins 48. This allows the legs 47 to be removed when supporting the system 10 in a vertical position is not necessary. As shown in FIG. 10, foldable legs 50 are secured to the base 17 by supports 49 which allow the legs 50 to pivot between a use position and a non-use position about pin 51.

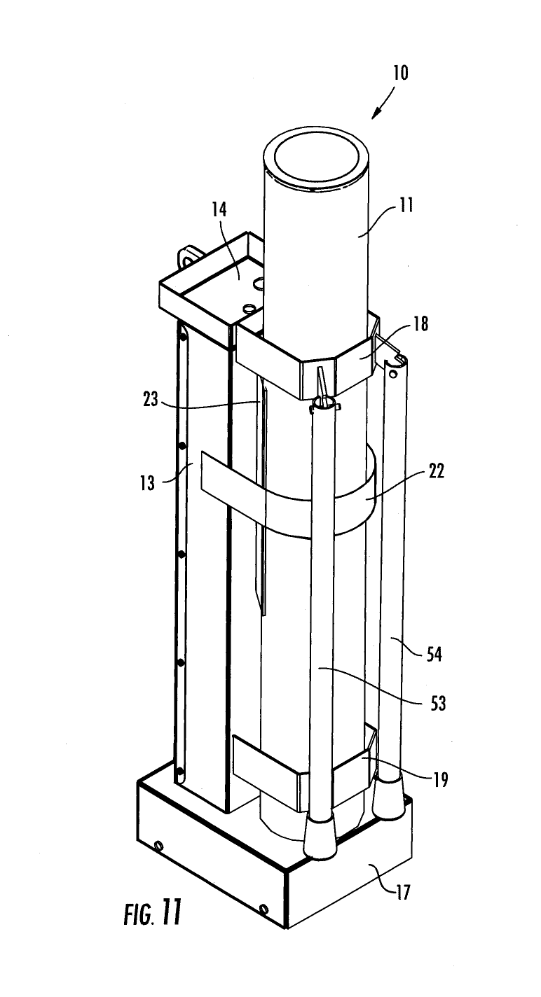

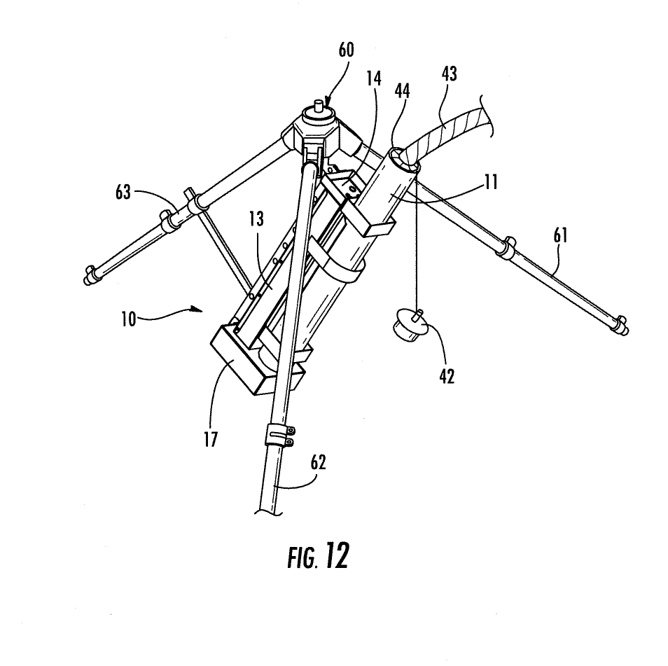

Other support methods may also be employed. For example, in FIG. 11, a bi-pod having legs 53 and 54 may be attached to strap 18. The legs 53 and 54 may be moved between a use position and a non-use position to allow the system 10 to be supported in a non-vertical position. As shown in FIG. 12, a tri-pod 60 may also be used to support the system 10. As shown, the tri-pod 60 includes adjustable legs 61, 62, and 63 to allow for adjustment on uneven surfaces. The system 10 is then hung from the tri-pod 60 using the attachment rail 16.

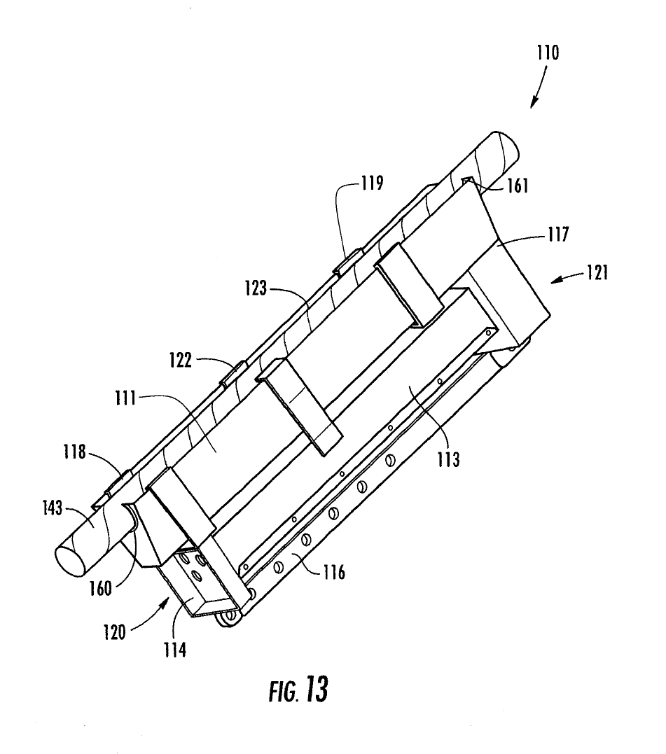

Referring to FIG. 13, a conductor cleaning system 110 is shown. Like system 10, system 110 includes a container 111 operably connected to a vibrator contained in a vibrator housing 113, a control panel 114, an attachment rail 116, a base 117, and retaining straps 118, 119, and 122. Unlike system 10, the container 111 of system 110 is a trough-like container to allow cleaning of a conductor 143 at a point intermediary of opposing ends of the conductor 143 without cutting. This allows the conductor 143 to be cleaned at locations where compression fittings, such as repair sleeves and T-connections, are being installed along the conductor 143.

In use, the container 111 is positioned at a point along the conductor 143 where cleaning is desired and moved into engagement with the conductor 143. Seals 160 and 161 permit the conductor 143 to be pressed into the container 111 until the conductor 143 is immersed in the cleaning solution. The seals 160 and 161 prevent the cleaning solution from leaking between the container 111 and the conductor 143.

The foregoing has described a conductor cleaning system. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We claim:

1. A method of determining when to replace a cleaning solution in a conductor cleaning system with a new cleaning solution, comprising:
(a) measuring a pH of the cleaning solution prior to and after each cleaning of multiple electrical conductors;
(b) calculating a drop in pH of the cleaning solution for each cleaning using the pH measurements taken prior to and after each cleaning of the electrical conductors;
(c) determining a range of drop in pH using the calculated drops in pH for each cleaning; and
(d) replacing the cleaning solution with the new cleaning solution when a calculated drop in pH exceeds the determined range of drop in pH.

2. The method according to claim 1, wherein the cleaning solution includes ascorbic acid.

3. The method according to claim 2, wherein the ascorbic acid protects an aluminum-zinc coating on a conductor being cleaned by the cleaning solution.
